(19) United States
(12) Patent Application Publication
(10) Pub. No.: US 2007/0077931 A1
(43) Pub. Date: Apr. 5, 2007

(54) Method and apparatus for wireless network protection against malicious transmissions

(76) Inventor: Michael Frank Glinka, Nuremberg (DE)

Correspondence Address: Lucent Technologies Inc.;Docket Administrator - Room 3J-219, 101 Crawfords Corner Road, Holmdel, NJ, 07733-3030, US

(21) Appl. No.: 11/242,397

(22) Filed: Oct. 3, 2005

(51) Int. Cl. H04Q 7/20

(52) U.S. Cl. 455/445; 455/466

(57) ABSTRACT

A method and apparatus are provided for protecting a wireless network from malicious code transmitted from a user terminal. Traffic from user terminals which flows over the air-interface is filtered and evaluated according to a set of rules imposed by the network, or specified by the user, or both. If the evaluation indicates that the traffic is offensive, further traffic from the offending user is blocked, and optionally, the offense is reported. As a consequence, a user can be protected from unwanted traffic that has been destined to terminate on his mobile, and protected from having his own mobile make undesired transmissions.

### FIELD OF THE INVENTION

This invention relates to security in wireless communication networks.

### ART BACKGROUND

It has become commonplace to use mobile phones for making voice calls or for sending messages via a SMS service. Recently, however, the mobile phone market has seen the introduction of smartphones. These devices incorporate at least some of the functionality of personal computers. As a consequence, they can, among other things, run software programs, receive email, make automatic calls, maintain open internet connections, browse the Web, and act under remote control. It is well known that personal computers are vulnerable to viruses, Trojan horse programs, and other forms of malicious code, and can propagate such code over the communication networks to which they are attached. With the expanded computational functionality of mobile phones, they, too, can suffer damage from malicious code and can propagate it over the wireless network. A mobile communication device or other user terminal may become infected, for example, over the air interface, or from a bluetooth, WiFi, or infrared connection.

This threat has been recognized. In response, antivirus programs have been made available for protecting mobile communication devices such as smartphones. However, these products fail to address the threat to the wireless network from malicious code that might be transmitted on the uplink from a mobile device or other user terminal.

### SUMMARY OF THE INVENTION

I have found a way to protect the wireless network from malicious code transmitted from a user terminal. In accordance with my development, traffic from user terminals which flows over the air-interface is filtered and evaluated according to a set of rules imposed by the network, or specified by the user, or both. If the evaluation indicates that the traffic is offensive, further traffic from the offending user is blocked, and optionally, the offense is reported. As a consequence, a user can be protected from unwanted traffic that has been destined to terminate on his mobile, and protected from having his own mobile make undesired transmissions.

### BRIEF DESCRIPTION OF THE DRAWING

FIG. 1 is a high-level conceptual drawing of a portion of a wireless network, including a base station equipped with a firewall as described herein.

### DETAILED DESCRIPTION

The methods to be described below can be applied independently of any specific wireless technology such as UMTS, CDMA, or GSM. Moreover, they can be applied in respect of any fixed or mobile user served by the network, independently of the type of operating system and user terminal.

For purposes of illustration, the user terminal will often be referred to, below, as a “mobile terminal.” However, this choice of terminology is not meant to be limiting. It will be understood that the same methods apply to any other type of user terminal, including fixed terminals, and that the scope of the invention is not limited to a terminal of any particular sort.

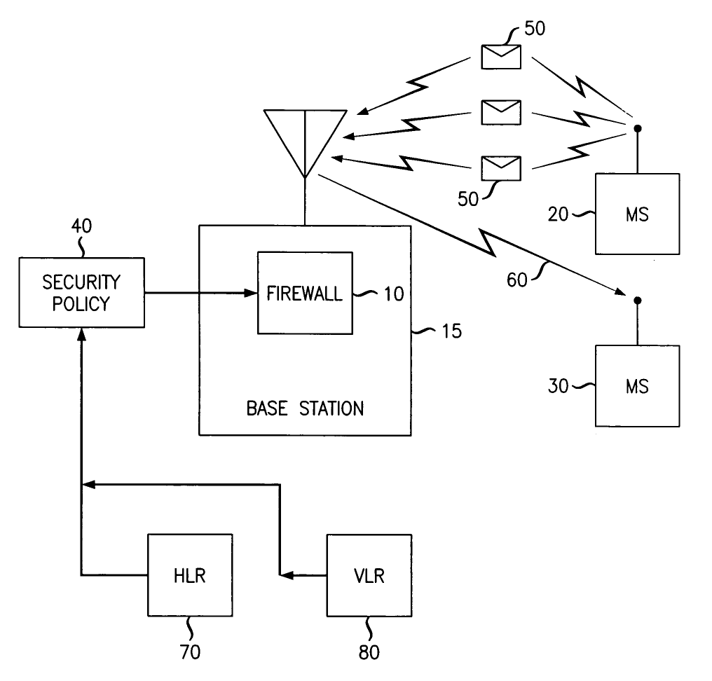

One attack route for malicious code is via the Short Messaging System (SMS) if available on the network. SMS messages are normally processed (depending on whether the technology is, e.g., GSM, UMTS, or CDMA) by a SMS message center. Protection against unwanted messages launched by malicious code can be provided by a filter implemented as a SMS/MMS firewall. Such a firewall is advantageously installed at the earliest feasible processing stage in the network. With reference to FIG. 1, for example, it would be advantageous to implement firewall 10 at base station 15 (or, e.g., a Node B of a UMTS network) at the level directly following the air interface.

Such a solution could also be effective to block virulent mass traffic to and from mobiles within the core network. Advantageously, such a solution will protect a user 20, 30 from unwanted traffic that has been destined to terminate on his mobile, and will protect the user from having his own mobile make undesired transmissions.

One type of rule that could be implemented by the SMS/MMS firewall would relate to the number of SMS messages sent by a mobile within a specified time frame. That is, the user, e.g., causes a security policy 40 to be applied. The security policy includes a maximum number of SMS messages 50 that may be sent by the mobile within a specified length of time. If this number of messages is exceeded, the firewall causes the mobile to be blocked. Optionally, a notification may be sent to the user, informing him that his mobile is behaving in an unauthorized or virulent manner.

More specifically, the firewall or filter at the base station counts the number of, e.g., SMS transmissions, MMS transmissions, calls, or data connections received in a given time frame. If the number exceeds the user's previously defined threshold or otherwise violates his applied security policy, then all traffic of this mobile will be directly blocked and the mobile user may be paged with a message notifying him that his mobile is behaving in a virulent matter. However, a predefined “white list” of permitted connections, such as emergency numbers, may still be permitted.

Another type of rule can apply a blacklist of numbers, maintained at the Node B (more generally, the “base station”) and updated by the operator, that are prohibited from connecting with the mobile. Blacklisted and blocked numbers may include, e.g., telephone numbers, Web pages, email addresses, and data connections. For updating of blacklists, fraudulent or malicious cases may be reported to a central database at, e.g., the HLR 70 and VLR 80, as well as reported to the mobile user. To exclude blacklisted calls, the firewall or filter may, e.g., monitor not only calls transmitted from the mobile, but also calls to be transmitted over the air interface to the mobile. (At least some blacklisted calls may be excluded as a result of monitoring the call set-up messages. In this regard, it may in at least some cases be sufficient to monitor only those set-up messages transmitted from the mobile.)

A user may have a personal filter configured according to his own security policy. Generally, the user will wish to prevent virulent behavior by his own mobile, and to be protected from being charged for the use of expensive services 60 which were invoked without his knowledge or consent. If the user leaves the filter unconfigured, or specifies that the security policy should be inactive, the user will experience normal, unprotected network behavior.

Part of the policy defined by the user may be an explicit exclusion of certain services. For example, the user explicity says, in effect, “I do not want E-bay pages to be accessed by my mobile until further notice.” (E-bay, of course, is only one example of many types of services that might be excluded in this regard.)

The service provider may also administer a security policy, which may be additional to that defined by the user, and which may be subject to the user's consent. A network security policy may, for example, provide enhanced protection against present and future types of malicious code attacks. In particular, the network provider can provide a list that updates the base stations with known malicious connections.

Through its security policy, the network may also protect itself from being overloaded by massive amounts of irrelevant traffic. Such an undesirable scenario might arise, for example, if a virus causes a large group of mobiles to generate undesired SMS or MMS traffic all at the same time.

In this regard, it may be useful in some cases to add a filter or firewall as described above to enhance the security of a base station that covers a building, office park, stadium, or other area where there is a concentration of fixed or temporarily non-mobile users. The enhanced security may be useful, for example, to deter the type of attack scenario in which malicious code causes the concentrated user terminals to overwhelm the serving cell with traffic generated all at the same time.

It will be advantageous to a mobile user for the security policy to continue to apply after handover so that a moving user can experience uninterrupted protection. This can be achieved if, for example, a count of (potentially virulent) received calls (including, e.g., SMS, MMS, or data connections) is maintained not only at the base station, but also at the next network instance, such as the base station controller or RNC.

In general, when a call is made to a mobile terminal, the network will identify the called mobile and the location of the called mobile. Thus, those mobiles that have already been identified as virulent and for that reason have been blocked, can remain in “blocked” status until, e.g., the user sends a clearance message, or (in an emergency, for example) switches off his personal firewall.

It will be understood that various formats and protocols may be used for the exchange of control messages needed for implementation of the filter and security policy. For example, control messages may be exchanged using normal traffic channels or, e.g., unused bandwidth or unused slots of control messages of other types.

In some cases, a user might wish to generate mass traffic, i.e., a large number of similar short messages within a short time period. For example, the user might wish to send meeting invitations to all the addresses on a long list of possible participants. Such mass traffic would be benign and not virulent. To permit such traffic to pass through the firewall, the user could, for example, send a notice to the firewall announcing that he will—immediately or within a specified time frame—send a mass SMS or other type of transmission.

What is claimed is:

1. A method for suppressing unwanted traffic in a wireless communication network, comprising:
at a base station, applying a security policy to call traffic received by the base station from a user terminal, thereby to determine whether the call traffic is undesirable; and
if the call traffic is determined to be undesirable, blocking at least some further call traffic from the user terminal.

2. The method of claim 1, wherein the step of applying a security policy comprises counting a number of calls sent within a time interval, and comparing the number with a threshold.

3. The method of claim 1, wherein the step of applying a security policy comprises determining whether the user terminal is sending an excessive number of SMS messages.

4. The method of claim 1, wherein the step of applying a security policy comprises comparing requested connections against a list of prohibited connections, and the blocking step comprises blocking connection if they are found on the list.

5. A security system at a base station of a wireless communication network, comprising:
a circuit adapted to measure call volume per a time interval from individual user terminals and to indicate if said volume exceeds a threshold; and
a circuit adapted to respond to said indications by blocking at least some further traffic from the user terminal in respect to which said indications have been made.

6. The security system of claim 5, further comprising a database of prohibited connections and a circuit adapted to indicate if a prohibited connection is being attempted, and wherein the blocking circuit is further adapted to block said attempts to make prohibited connections.
